(19) United States
(12) Patent Application Publication
(10) Pub. No.: US 2026/0111480 A1
(43) Pub. Date: Apr. 23, 2026

(54) FEATURE INFORMATION COMPARISON METHOD AND SYSTEM FOR MULTIMEDIA SEARCH

(71) Applicant: GMDSOFT INC., Seongnam-si (KR)

(72) Inventors: Seong Min LEE, Hwaseong-si (KR); Paul KIM, Gwangju-si (KR); Kyung Su LEE, Uiwang-si (KR); Hyun Soo KIM, Seongnam-si (KR)

(73) Assignee: GMDSOFT INC., Seongnam-si (KR)

(21) Appl. No.: 19/332,643

(22) Filed: Sep. 18, 2025

(30) Foreign Application Priority Data
Oct. 23, 2024 (KR) 10-2024-0145558

(51) Int. Cl. G06F 16/45; G06F 16/483

(52) U.S. Cl. CPC G06F 16/45; G06F 16/483

(57) ABSTRACT

A feature information comparison system includes a feature information extractor configured to extract feature information from each of a plurality of multimedia data, a quantization processor configured to quantize the extracted feature information and store it in a feature information database, a clustering processor configured to cluster a set of target multimedia data using the feature information, calculate centroid for each cluster, and store the centroids in a cluster database, a cluster searcher configured to compare the quantized feature information extracted from a search input with the cluster centroids in the cluster database, select similar clusters based on the comparison, and designate the multimedia data in the selected clusters as search candidates, and a search result provider configured to compare the feature information of the multimedia data in the selected clusters with the feature information of the search input and provide a final search result based on the comparison.

### CROSS-REFERENCE TO RELATED APPLICATION

This application claims priority from and the benefit of Korean Patent Application No. 10-2024-0145558 filed on Oct. 23, 2024, in the Korean Intellectual Property Office, the disclosure of which is incorporated herein by reference.

### BACKGROUND OF THE DISCLOSURE

### Field of the Disclosure

Example embodiments relate to a feature information comparison method and system for multimedia search, and more particularly, to a technology that improves search efficiency by performing clustering and similarity comparison using quantized feature information.

### Description of the Related Art

Multimedia search technology has been rapidly advancing to efficiently retrieve various types of multimedia data such as images, videos, audio, and documents.

Recently, deep learning-based feature extraction and embedding techniques have drawn considerable attention. In particular, methods that utilize neural network architectures such as Convolutional Neural Networks (CNNs) to extract feature vectors from multimedia data and convert them into embeddings are widely adopted. These methods map data into a low-dimensional latent space, allowing more accurate analysis of similarity between data. In application domains such as face recognition and image retrieval, deep learning models such as ArcFace or ResNet are commonly used to represent feature information as fixed-length vectors.

As vector-based similarity comparison becomes prevalent in multimedia search, efficient processing of high-dimensional vectors is gaining importance. Clustering algorithms such as DBSCAN and K-means are actively being studied to group similar vectors, narrow the search space, and reduce search time. However, such approaches require optimization to manage computational cost and data volume efficiently.

To improve search speed for large-scale multimedia data, quantization techniques that convert vector data into bit-level representations are also gaining traction. Quantization compresses high-dimensional floating-point vectors into low-bit values, reducing both memory usage and computational overhead. For example, converting a 32-bit floating-point value into a 2-bit quantized value can significantly accelerate processing. Moreover, by leveraging CPU-embedded functions to perform bitwise similarity operations such as XNOR, recent research demonstrates faster search performance compared to traditional cosine similarity methods.

Hybrid search techniques that combine clustering and quantization have also been introduced. These approaches first narrow the search space through clustering, then perform a first-stage similarity filtering using quantized feature information, followed by a second-stage precision similarity verification using floating-point feature information. Such hybrid methods are evolving as solutions that achieve both high accuracy and fast processing even in large-scale datasets. In particular, initial candidate selection using bitwise operations, followed by refined similarity evaluation, has gained popularity.

In typical multimedia search, similarity is calculated using high-dimensional feature vectors. As the volume of data increases, the computational cost grows significantly, resulting in slower search performance. Traditional similarity measures such as cosine similarity become less efficient in high-dimensional spaces due to the heavy computation. Although dimensionality reduction and quantization techniques are used to address this problem, they may degrade search accuracy. Therefore, there is a growing need for new quantization and clustering techniques that address both efficiency and precision in multimedia search.

### SUMMARY

The present invention is directed to reducing the computational cost that arises during large-scale search of multimedia data.

The present invention is directed to optimizing storage space and processing speed by quantizing high-dimensional feature vectors.

The present invention is directed to improving search speed by minimizing the computational load incurred during cosine similarity calculations.

The present invention is directed to classifying search targets efficiently through clustering and reducing the candidate set to shorten processing time.

The present invention is directed to achieving high accuracy and fast search performance even in large-scale multimedia data by utilizing quantized feature information.

According to an embodiment, a feature information comparison system for multimedia search may include: a feature information extractor configured to extract feature information of each multimedia data from a plurality of multimedia data, a quantization processor configured to quantize the extracted feature information and store the quantized feature information in a feature information database, a clustering processor configured to cluster a set of target multimedia data using the stored feature information, calculate a centroid of each cluster, and store the centroids in a cluster database, a cluster searcher configured to compare a quantized value of the feature information extracted from a search input with the centroids in the cluster database, select one or more similar clusters based on the comparison, and designate the multimedia data within the selected clusters as search candidates, and a search result provider configured to compare the feature information of the multimedia data within the selected clusters with the feature information of the search input and provide a final search result based on the comparison result.

In one embodiment, the feature information extractor may extract a feature vector of the input multimedia data using a CNN-based algorithm, and the quantization processor may convert the extracted feature vector using an n-bit quantization method.

In one embodiment, the clustering processor may cluster the quantized feature information using a DBSCAN clustering algorithm and calculate a centroid for each cluster.

In one embodiment, the cluster searcher may select c clusters similar to the quantized feature information of the search input, and may designate the search candidates based on the quantized values of the multimedia data included in each selected cluster.

In one embodiment, the search result provider may calculate a similarity by performing an XNOR operation between the quantized values and provide an optimal search result based on the calculated similarity.

In one embodiment, the cluster searcher may selectively use either a Euclidean distance or a cosine similarity method when calculating distances between centroids in the cluster database.

In one embodiment, the search result provider may perform a first similarity verification using the quantized values of the multimedia data in the candidate clusters, and then perform a second verification using actual feature information.

In one embodiment, the clustering processor may re-arrange clusters based on the quantized values of the multimedia data and automatically update the cluster centroids when new data is added.

According to an embodiment, a feature information comparison method for multimedia search may include: extracting a feature vector from multimedia data using a CNN-based algorithm, generating quantized feature information by applying an n-bit quantization method to the extracted feature vector, quantizing a feature vector extracted from a search input and comparing the quantized input value with centroids in a cluster database to select c similar clusters as search candidates, performing a first similarity verification by comparing the quantized feature information of the multimedia data in the selected clusters with the quantized feature information of the search input and filtering the candidate clusters based on the verification result, and comparing the actual feature information of the multimedia data in the filtered candidate clusters with the feature information of the search input and providing top-k data with the highest similarity as a final search result.

The method for feature information comparison for multimedia search according to one embodiment may further include: clustering a set of multimedia data by applying a DBSCAN clustering algorithm to the generated quantized feature information, calculating a centroid for each clustered cluster, storing, for each multimedia data, the generated quantized feature information, the quantized value, the cluster ID, and the cluster centroid in a feature information database, and storing the cluster information in a cluster database.

The step of performing the first similarity verification according to one embodiment may include: calculating a similarity between the quantized feature information of the search input and the quantized feature information within the cluster using an XNOR operation, and optimizing the calculation speed using a PopCount function. According to one embodiment, the amount of computation required for similarity comparison can be significantly reduced by using quantized feature information.

According to one embodiment, high-dimensional feature vectors can be efficiently clustered to effectively reduce the set of search candidates.

According to one embodiment, similarity can be calculated faster than with traditional cosine similarity methods by using an XNOR operation.

According to one embodiment, the speed of bitwise similarity computation can be maximized by utilizing a CPU-embedded function (PopCount).

According to one embodiment, fast yet accurate search can be achieved by combining a first-stage quantized comparison with a second-stage floating-point-based comparison to enhance search efficiency.

### BRIEF DESCRIPTION OF THE FIGURES

Embodiments will be described in more detail with regard to the figures, wherein like reference numerals refer to like parts throughout the various figures unless otherwise specified, and wherein:

FIG. 1 is a diagram illustrating a feature information comparison method for multimedia search according to one embodiment.

FIG. 2 is a diagram illustrating a method of constructing a cluster database according to one embodiment.

FIG. 3 is a diagram illustrating feature vectors passed through a CNN-based ImageNet classification model.

FIG. 4 is a diagram illustrating a feature information comparison system for multimedia search according to one embodiment.

### DETAILED DESCRIPTION OF THE DISCLOSURE

The specific structural or functional descriptions of embodiments disclosed in this specification according to the concept of the present invention are merely illustrative and are provided for the purpose of describing exemplary embodiments in accordance with the concept of the present invention. The embodiments in accordance with the concept of the present invention may be implemented in various forms and should not be construed as limited to the embodiments described herein.

The embodiments in accordance with the concept of the present invention may be subject to various modifications and may take on a variety of forms, and therefore, specific embodiments are illustrated in the drawings and described in detail in this specification. However, this is not intended to limit the embodiments to any particular forms of disclosure, and it should be understood to include modifications, equivalents, or substitutes that fall within the spirit and scope of the present invention.

Terms such as “first” or “second” may be used to describe various components, but these components should not be interpreted as being limited by such terms. These terms are used only to distinguish one component from another. For example, within the scope of the present invention, a first component could be referred to as a second component, and likewise, the second component could be referred to as the first component.

When a component is described as being “connected” or “coupled” to another component, it may be directly connected or coupled to the other component, or there may be one or more intervening components. In contrast, when a component is described as being “directly connected” or “directly coupled” to another component, there are no intervening components between them. Expressions describing relationships between components, such as “between” and “directly between” or “adjacent to,” should be interpreted in the same manner.

The terminology used in this specification is intended solely for the purpose of describing specific embodiments and is not intended to be limiting of the invention. As used herein, the singular forms also include the plural forms unless the context clearly dictates otherwise. As used herein, the terms “comprise,” “include,” or “have,” and any variations thereof, are intended to indicate the presence of stated features, integers, steps, operations, elements, or components, but do not preclude the presence or addition of one or more other features, integers, steps, operations, elements, components, or combinations thereof.

Unless otherwise defined, all terms used herein, including technical or scientific terms, have the same meaning as commonly understood by one of ordinary skill in the art to which this invention belongs. Terms generally defined in commonly used dictionaries should be interpreted in accordance with their meaning in the context of the relevant art and should not be interpreted in an idealized or overly formal sense unless explicitly defined otherwise herein.

Hereinafter, embodiments will be described in detail with reference to the accompanying drawings. However, the scope of the present application is not limited or restricted by these embodiments. The same reference numerals used in the drawings denote the same elements throughout.

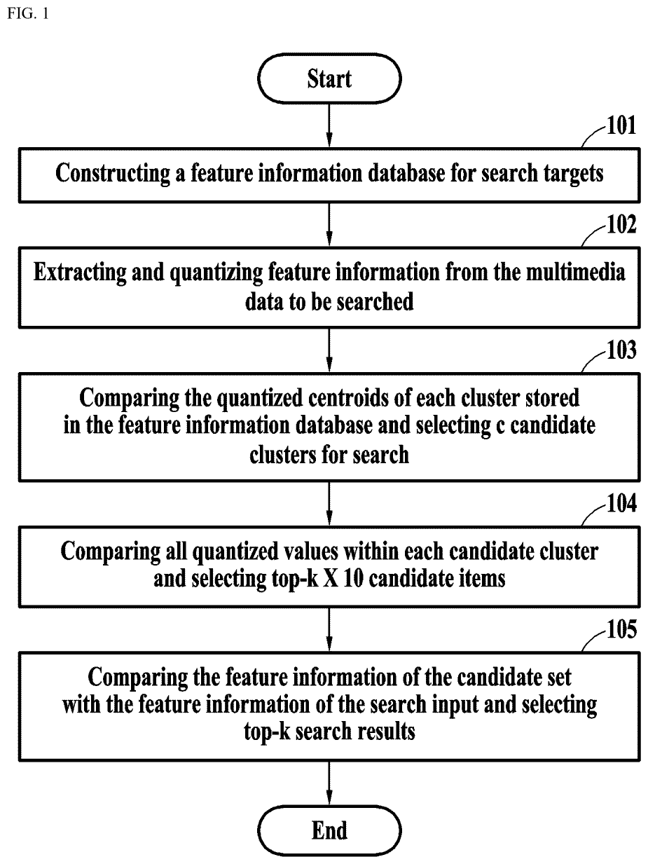

FIG. 1 is a diagram illustrating a feature information comparison method for multimedia search according to one embodiment.

The feature information comparison method for multimedia search according to one embodiment may include constructing a feature information database of search targets (101).

In step 101, feature information may be extracted from multimedia data and stored in a database. The feature information may be extracted using a Convolutional Neural Network (CNN)-based algorithm and represented in the form of a vector to reflect the unique characteristics of the multimedia data. Such feature information may serve as fundamental data for comparison during search.

Feature information refers to numerically expressed values that represent the inherent attributes of a given data, thereby enabling comparison and analysis by quantifying the essential characteristics and patterns of the data. The information is typically expressed as a continuous floating-point vector and can be extracted from various forms of data—such as images, text, or audio—by converting them into vector representations. These vectors include key components and discriminative elements of the data and can be adjusted by dimensionality reduction or expansion.

Feature information is the result of converting the inherent patterns and attributes of data into a numerical vector. For example, in the case of image data, a CNN (Convolutional Neural Network) model may be used to quantify the prominent features of each image, represent them as continuous floating-point values, and organize them into vectors. These feature vectors may numerically represent visual elements such as size, shape, color, and edges of the image.

When the same data is input, the feature information consistently generates the same feature vector, enabling precise search and classification of identical data. Conversely, when similar data is input, similar feature vectors are produced, which makes it possible to group or retrieve data with similar properties. For instance, in a face recognition system, when multiple images of the same person are provided, the same feature vector can be generated to identify the individual accordingly.

Next, the feature information comparison method for multimedia search according to one embodiment may extract feature information of the multimedia to be searched and subsequently perform quantization (102).

Quantization refers to the process of converting a floating-point vector into low-bit values, and in step 102, an n-bit quantization method may be used.

The process of extracting and quantizing feature information of the target multimedia is intended to numerically represent the unique patterns of multimedia data (e.g., images, videos, etc.) and enable efficient processing through quantization.

In the feature information extraction step, a deep learning model such as a Convolutional Neural Network (CNN) may be used to extract feature information from multimedia data. This model learns visual elements such as patterns, shapes, and colors in images or videos and represents them as vectors composed of floating-point values. For example, when a facial image is input, the CNN model may extract the key facial features and express them in the form of a feature vector. This vector consists of multiple floating-point values, and its dimensionality may vary depending on the architecture of the model and the size of the input data.

In the quantization step of the floating-point values, the extracted feature information appears in the form of a vector composed of floating-point values. Since such vectors are computationally expensive and require large memory usage, quantization may be used to enhance efficiency.

During the quantization process, the floating-point values are compressed and represented in binary format.

For example, a floating-point value represented in 32 bits may be quantized into a 2-bit value. The resulting quantized vector converts high-dimensional floating-point data into low-bit binary values, thereby reducing both processing speed and memory usage.

In the similarity calculation step using bitwise operations, the quantized feature information is composed of 2-bit values, enabling faster computation. Since bitwise operations are used instead of floating-point operations, the computation speed can be significantly improved.

For instance, while conventional inner product calculations using floating-point values require multiplication, quantized binary data allows similarity to be calculated through simple bit counting. This process can be further accelerated using a CPU-embedded function such as the PopCount function.

The quantized feature information may be stored in a database and efficiently utilized during the search process. Because quantized data requires less memory, it allows efficient storage and retrieval even in large-scale multimedia datasets.

The feature vector quantization method refers to the process of converting high-dimensional vectors composed of floating-point values into binary representations, thereby improving computational efficiency by transforming real values into bits to enhance processing speed and reduce memory consumption.

The feature vector quantization algorithm converts each element of the feature vector into bit-level representation to maximize computational efficiency. This algorithm compresses the vector composed of floating-point values into low-bit values, enhancing both processing speed and memory efficiency.

To achieve this, the input feature vector must first be provided, and the absolute value of each element must be computed.

First, a feature vector v={S₀, S₁, . . . Sₙ} extracted using a CNN or another deep learning model may be received as input.

The feature vector is composed of floating-point values, and each scalar value Sᵢ may represent an element of the feature information.

The absolute value of each element Sᵢ in the vector is calculated to obtain

$${S}_{i}^{abs} ,$$

resulting in all values in the vector being converted to positive values, which may be used for subsequent sorting or threshold value calculation.

When all values

$${S}_{i}^{abs}$$

are sorted in descending order, they are arranged from the largest to the smallest. For example, an array K may be generated, in which Kᵢ may indicate the index of

$${S}_{i}^{abs}$$

in the descending order.

Among the sorted values, the median value may be set as a threshold value δ. In other words, the value corresponding to the central index c of array K may be identified and assigned as the threshold value δ.

For example, when the length of the vector is even, the value δ may be calculated by taking the average of the two central values.

Next, based on the index array K, the vector may be divided into a top 50% and a bottom 50%. The top 50% may be defined as O={K₀, K₁, . . . , K_{n/2}} and the bottom 50% may be defined as P={K_{n/2+1}, . . . , Kₙ}.

An index i in the top 50% array O may satisfy condition

$${S}_{i}^{abs} > δ .$$

In contrast, an index i in the bottom 50% array P may satisfy condition

$${S}_{i}^{abs} > δ .$$

Meanwhile, for each index i belonging to array P, the corresponding value Sᵢ may be replaced with the bit ‘01’. Since it corresponds to a value in the bottom 50%, it may be set to the binary value ‘01’ to enhance the discriminative power of the feature vector.

For each index i in array O, the bit value may be set according to the sign of Sᵢ.

If Sᵢ≥0 (a positive value), the value may be replaced with the bit ‘11’; if Sᵢ<0 (a negative value), the value may be replaced with the bit ‘00’. This allows for clear distinction between positive and negative values.

All scalar values are replaced with bits based on the above rules to generate the final quantized vector Q={b₀, b₁, . . . , bₙ}.

Each bᵢ element represents the bitwise expression of Sᵢ, and the quantized vector replaces the original floating-point vector for computation, enabling fast similarity comparison using bitwise operations only.

As a specific example, it may be assumed that a feature vector extracted using a CNN model is composed of the following ten floating-point values:
[0.7, −1.2, 0.3, −0.8, 1.0, 0.6, −0.5, 0.4, −0.9, 1.1]

By taking the absolute value of each scalar in the vector, an absolute value vector is generated as follows:
[0.7, 1.2, 0.3, 0.8, 1.0, 0.6, 0.5, 0.4, 0.9, 1.1]

Next, sorting these absolute values in ascending order results in:
[0.3, 0.4, 0.5, 0.6, 0.7, 0.8, 0.9, 1.0, 1.1, 1.2]

From the sorted values, a threshold value may be selected based on the central position. Since the length of the vector is 10, the central values lie between the fifth and sixth elements.

By averaging these two values (0.7 and 0.8), the threshold may be calculated as: (0.7+0.8)/2=0.75

Using the computed threshold value (0.75), quantization may be performed on each scalar of the original feature vector.

If a value is in the top 50% (i.e., its absolute value is greater than or equal to the threshold) and is positive, it may be quantized to 3, represented in binary as ‘11’.

If a value is in the top 50% and is negative, it may be quantized to 0, represented as ‘00’.

If a value is in the bottom 50% (i.e., its absolute value is below the threshold), it may be quantized to 1, represented as ‘01’, regardless of sign.

Applying this quantization rule to the example vector [0.7, −1.2, 0.3, −0.8, 1.0, 0.6, −0.5, 0.4, −0.9, 1.1] the result can be organized as follows:

$$\begin{matrix}0.7 ( within bottom 50 \% ) : quantized to 1 -> represented as ' 01 ' \\ - 1.2 ( within top 50 \% , negative ) : quantized to 0 -> represented as ' 00 ' \\ 0.3 ( within bottom 50 \% ) : quantized to 1 -> represented as ' 01 ' \\ - 0.8 ( within top 50 \% , negative ) : quantized to 0 -> represented as ' 00 ' \\ 1. ( within top 50 \% , positive ) : quantized to 3 -> represented as ' 11 ' \\ 0.6 ( within bottom 50 \% ) : quantized to 1 -> represented as ' 01 ' \\ - 0.5 ( within bottom 50 \% ) : quantized to 1 -> represented as ' 01 ' \\ 0.4 ( within bottom 50 \% ) : quantized to 1 -> represented as ' 01 ' \\ - 0.9 ( within top 50 \% , negative ) : quantized to 0 -> represented as ' 00 ' \\ 1.1 ( within top 50 \% , positive ) : quantized to 3 -> represented as ' 11 '\end{matrix}$$

Through this process, the quantized vector may be converted as follows:
[‘01’, ‘00’, ‘01’, ‘00’, ‘11’, ‘01’, ‘01’, ‘01’, ‘00’, ‘11’].

The quantized vector is stored in a way that maximizes computational efficiency and enables fast calculation during similarity comparison.

Since only bitwise operations are used for comparison, there is no need to retain the original floating-point vector.

Moreover, this allows even faster processing by utilizing CPU-embedded functions such as the PopCount function.

Through this quantization process, the feature information of multimedia data can be converted into low-bit binary values, thereby reducing computational load and significantly improving memory efficiency.

During the search process, the feature information of the input data is quantized and compared with the quantized data stored in the database to calculate similarity and quickly identify the most similar data.

Next, the feature information comparison method for multimedia search according to one embodiment may select c candidate clusters by comparing the quantized centroid values of the clusters stored in the feature information database (103).

In step 103, c clusters similar to the quantized feature information of the search input may be selected from the clustered feature information database.

By comparing the centroid of each cluster with the quantized value of the input, similar clusters may be selected as candidates, which narrows the search space, reduces computational cost, and enables faster searching.

Next, the feature information comparison method for multimedia search according to one embodiment may compare the quantized values of each candidate cluster to select a candidate set (104).

In step 104, all quantized values within the selected clusters are compared with the quantized input to select a candidate set of top-k X 10 data.

Bitwise operations such as XNOR may be used in this step to efficiently compute the similarity between quantized feature information.

In the present invention, an XNOR operation may be employed to calculate the similarity between quantized feature information.

For example, similarity may be calculated by converting values such as 0, 1, and 3 into their corresponding bit representations.

First, when comparing two quantized values, an XNOR operation is performed. The XNOR operation outputs 1 when the two input values are the same, and 0 when they are different.

In the present invention, the quantized values 0, 1, and 3 are used and represented in 2-bit format to enable XNOR operation. For example, the value 3 is represented as ‘11’, the value 1 as ‘01’, and the value 0 as ‘00’.

When comparing identical values, the XNOR operation between the corresponding elements of two quantized vectors produces ‘11’, thereby maintaining a high similarity score.

For instance, when comparing 3 and 3, ‘11’ XNOR ‘11’ results in ‘11’.

In contrast, when comparing different values, the XNOR operation outputs ‘00’, indicating low similarity.

For example, comparing 3 and 1 involves performing ‘11’ XNOR ‘01’, which results in ‘01’.

This approach allows partial matches to be distinguished from complete mismatches, thus improving the discriminative power of the similarity calculation.

Next, the total number of is in the bit array resulting from the XNOR operation is counted. This count becomes the key factor in calculating similarity.

The PopCount function, a CPU-embedded instruction, may be used to efficiently count the number of Is, significantly accelerating the similarity calculation.

Specifically, the similarity score S may be calculated as the ratio of the number of is to the total number of bits, yielding a value between 0 and 1.

A score closer to 1 indicates a higher similarity between the two vectors.

The total number of bits is determined by the length (i.e., dimensionality) of the quantized vectors.

Since each scalar value is quantized into 2 bits, the total number of bits equals twice the number of dimensions in the vector.

For example, if the vector has 512 dimensions, the total number of bits would be 1024.

This similarity comparison method enables very fast computation by utilizing XNOR operations and the PopCount function, and provides high discriminative power in similarity evaluation by precisely distinguishing between matching and non-matching values.

Even when some bits are partially the same, this method can differentiate them from fully mismatched values, enabling fine-grained retrieval of multimedia data.

In the present invention, the performance of the XNOR-based method was evaluated through the following experiment, in comparison with conventional similarity comparison methods.

The objective of this experiment is to assess the improvements in computation time and accuracy achieved by the proposed algorithm, compared to a conventional similarity calculation method using Float32 floating-point values.

Specifically, a 512-dimensional feature vector was generated using the ArcFace model.

The dataset consisted of 30,000 and 100,000 entries, respectively, each containing face images of 1,000 and 3,300 individuals captured under various conditions for testing.

The goal of the experiment is to evaluate the accuracy of retrieving the correct identity for a given query across each dataset (30,000 and 100,000 entries) by using a single query per test.

The accuracy is calculated using Equation [1].

$$Accuracy = \frac{{K}_{s}}{{N}_{s}} \times 100 \qquad [ Equation 1 ]$$

Ns represents the total number of facial images belonging to the same identity as the query, and Ks represents the number of facial images of the same identity included in the retrieved Top-K results.

For each dataset, similarity was calculated using the query, and the average accuracy was measured. In addition, the average time per query was recorded to evaluate the speed of the XNOR operation-based algorithm.

TABLE 1

| | Top k = 50, Vector Length = 512 | | | |
|---|---|---|---|---|
| | Average Accuracy (%) | | Average Query Time (ms) | |
| | 30K | 100K | 30K | 100K |
| Float32 | 87.64 | 83.68 | 15 | 60 |
| (Baseline) | | | | |
| Float32 | 87.61 | 83.67 | 9 | 71 |
| DBSCAN | | | | |
| Cluster 10% | | | | |
| (Compare Top | | | | |
| 10% Near | | | | |
| Clusters) | | | | |
| 1st Comparison | 87.43 | 83.41 | 4 | 10 |
| Uint64 −> 2nd | | | | |
| Comparison Top | | | | |
| K × 10 Float32 | | | | |
| 1st Comparison | 87.45 | 83.44 | 2 | 11 |
| Uint64 | | | | |
| DBSCAN | | | | |
| Cluster 10% | | | | |
| (Compare Top | | | | |
| 10% Near | | | | |
| Clusters) −> 2nd | | | | |
| Comparison Top | | | | |
| K × 10 Float32 | | | | |

As shown in Table 1, the experimental results indicate that the conventional Float32 method achieved an average accuracy of 87.64% on the 30,000-item dataset, with an average query time of 15 ms per query.

On the 100,000-item dataset, the average accuracy was 83.68%, with an average query time of 60 ms.

In contrast, the algorithm proposed in the present invention reduces the number of feature comparisons through a first-stage comparison using quantized vectors, and guarantees accuracy through a second-stage comparison using Float32 values.

Notably, when DBSCAN clustering was applied in the first-stage comparison, the method was able to maintain accuracy while further reducing the query time.

According to the invention, the average query time was measured at 4 ms for the 30,000-item dataset and 10 ms for the 100,000-item dataset.

This represents a significant improvement in speed compared to the conventional Float32 method.

Although a slight decrease in accuracy was observed in the 100,000-item dataset, the overall query time was substantially reduced.

Furthermore, in the method utilizing the DBSCAN algorithm, the average query time on the 30,000-item dataset was reduced to 2 ms, demonstrating even faster performance.

On the 100,000-item dataset, the query time was comparable to the non-DBSCAN method, but a slight improvement in average accuracy was observed.

These results demonstrate the effectiveness of the proposed algorithm for large-scale data retrieval.

In conclusion, compared to conventional similarity computation using Float32 values, the method of the present invention significantly improves computation speed without substantially degrading accuracy.

In particular, by combining pre-filtering through clustering and similarity evaluation based on XNOR operations, the proposed method enables fast and efficient search even for large-scale multimedia datasets.

Next, the feature information comparison method for multimedia search according to one embodiment may compare the similarity between the feature information of the input and that of the candidate set to determine the final search result (Step 105).

Finally, the feature information comparison method according to one embodiment may compare the actual feature information of the multimedia data in the candidate set with the feature information of the search input, and provide the final top-k search results (Step 106).

In step 106, a second-stage similarity calculation based on floating-point values is performed to derive the final result with high accuracy, thereby maintaining optimal retrieval performance.

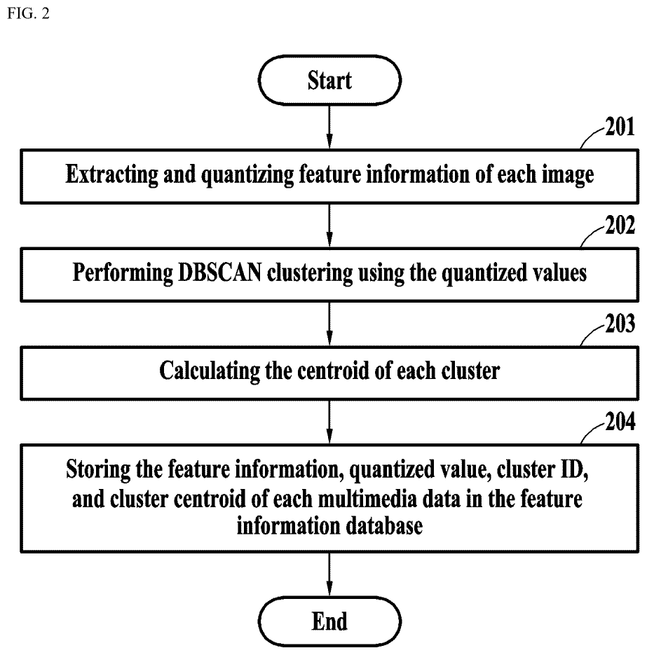

FIG. 2 is a diagram illustrating a method for constructing a cluster database according to one embodiment.

The method for constructing a cluster database according to one embodiment may begin by extracting and quantizing the feature information of each image (Step 201).

In the first step, a feature vector may be extracted from multimedia data (e.g., an image) using a CNN-based algorithm.

This feature vector contains unique information about each image and serves as a basis for subsequent search and comparison.

The extracted feature vector is then compressed into a low-bit value through an n-bit quantization process, which reduces memory usage and increases processing speed.

For example, a vector represented by floating-point values may be quantized into 2-bit binary values to enable bitwise operations.

The method for constructing a cluster database according to one embodiment may perform DBSCAN clustering using the quantized values (Step 202).

In this step, multimedia data may be clustered using the DBSCAN clustering algorithm based on the quantized feature information.

DBSCAN is a density-based clustering algorithm that can group data with similar quantized values into the same cluster.

This enables efficient identification of similar data in high-dimensional space and allows the search range to be significantly reduced.

According to the present invention, a centroid may be calculated for each cluster (Step 203).

For each cluster formed through DBSCAN clustering, a centroid may be calculated.

The centroid may be defined as the average or median of all data points within the cluster and may serve as a comparison reference during the search process.

By storing the centroid, clusters with similar centroid values can be quickly filtered prior to performing detailed comparisons, thereby improving search efficiency.

The feature information, quantized value, cluster ID, and cluster centroid of each multimedia data may be stored in the feature information database (Step 204).

In the final step, for each multimedia data, the extracted feature information, the quantized value, the ID of the cluster to which the data belongs, and the centroid of that cluster are stored in the feature information database.

This stored information can be effectively used for fast comparison and filtering during the search process.

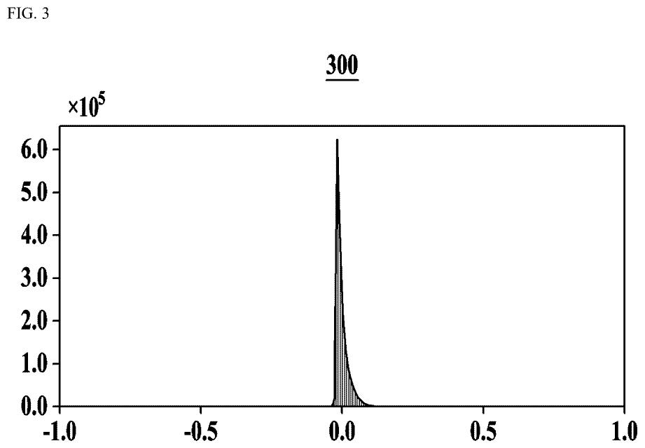

FIG. 3 is a diagram illustrating feature vectors passed through a CNN-based ImageNet classification model.

FIG. 3 shows a graph representing the distribution of feature vectors extracted using a CNN-based ImageNet classification model.

The graph demonstrates that the scalar values of the feature vectors tend to be concentrated around zero, and such distribution plays an important role in the quantization process.

Feature vectors extracted through a CNN-based model are typically composed of floating-point values, with each scalar value distributed within a specific range.

As shown in FIG. 3, most values are densely clustered near zero.

This distribution characteristic may indicate that the model has learned to focus on the most significant features in the data.

By utilizing the fact that the feature vector values are concentrated around zero, quantization can be applied.

During the quantization process, such distributions allow the values of the vectors to be represented using lower-bit formats.

As shown in the distribution graph in FIG. 3, quantization is performed by dividing values near zero into positive and negative regions, thereby compressing the feature vector.

This reduces computational cost and enables more efficient data representation for feature comparison.

Based on the distribution shown in FIG. 3, the quantized values of the feature vectors can preserve the learned patterns from the CNN model while replacing floating-point operations with bitwise operations.

As a result, instead of using conventional cosine similarity for comparison, faster similarity evaluation can be performed using bitwise operations.

By leveraging CPU-embedded functions such as PopCount, the computation speed can be maximized, enabling efficient search even in large-scale datasets.

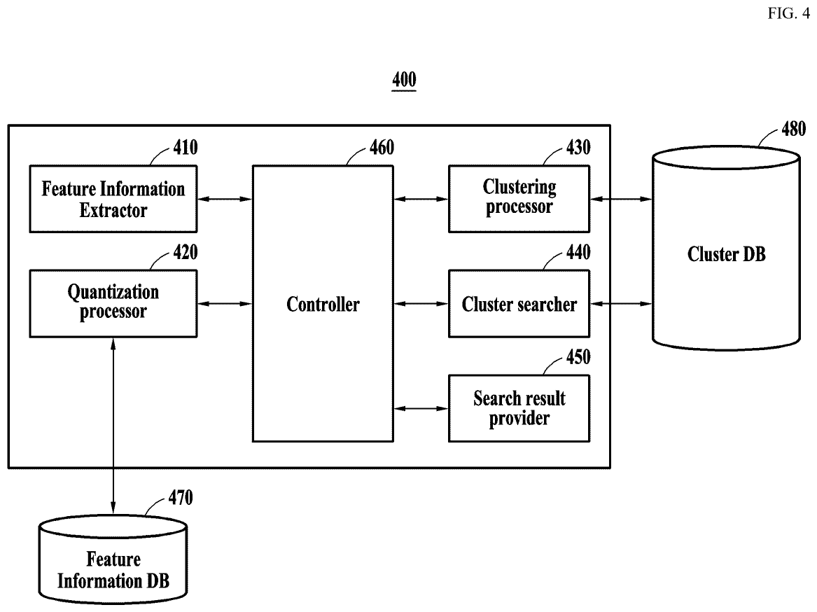

FIG. 4 is a diagram illustrating a feature information comparison system for multimedia search according to one embodiment.

The feature information extractor (410) extracts a feature vector from multimedia data (e.g., images or videos) using a CNN-based algorithm.

This feature vector numerically represents the unique patterns and characteristics of the multimedia data in vector form and serves as the basis for subsequent quantization and clustering processes.

The feature information extractor (410) may process data in real time and may utilize a high-performance neural network model for accurate and efficient feature extraction.

The quantization processor (420) may convert the extracted feature vector into an n-bit quantized format.

Quantization is the process of compressing high-dimensional floating-point vectors into low-bit values, which is essential for optimizing processing speed and memory usage.

The quantized feature information is stored in the feature information database (470) and may be used in later clustering and similarity comparison stages.

This module may utilize CPU-embedded functions to accelerate bitwise operations, enabling efficient transformation of the feature information.

Next, the clustering processor (430) clusters the multimedia dataset using the quantized feature information and calculates the centroid of each cluster to be stored in the cluster database (480).

This process may use a density-based clustering algorithm such as DBSCAN to group similar data.

The centroid of each cluster may later serve as a reference value for comparison with input data during the search process.

The clustering processor (430) is capable of performing fast and accurate clustering even on large-scale datasets.

The cluster searcher (440) may compare the quantized value of the feature information extracted from a search input with the cluster centroids stored in the cluster database to identify similar clusters.

This module narrows the search space by comparing the input data with the centroids of the clusters and designates high-similarity clusters as candidates.

The multimedia data within the selected clusters are used as search candidates in subsequent comparison stages, which significantly improves search speed.

The search result provider (450) may compare the feature information of the multimedia data within the selected clusters with that of the search input.

The search result provider (450) may rapidly compute the similarity between quantized feature information using bitwise operations such as XNOR, and, when necessary, perform a second-stage high-precision comparison using floating-point feature information.

Ultimately, it provides the top-k results with the highest similarity scores.

This ensures both high accuracy and fast response time within the system.

The controller (460) controls the overall operation of the system and manages data flow between modules.

It oversees the entire process—including feature extraction, quantization, clustering, searching, and result delivery—and coordinates the system to ensure optimized performance in real time.

The feature information comparison system (100) efficiently retrieves multimedia data using the feature information database (470) and the cluster database (480), while maintaining high accuracy and providing fast processing speed.

The apparatus described above may be implemented using hardware components, software components, or a combination of both hardware and software components.

For example, the apparatus and components described in the embodiments may be implemented using one or more general-purpose or special-purpose computers, such as a processor, controller, arithmetic logic unit (ALU), digital signal processor (DSP), microcomputer, field programmable array (FPA), programmable logic unit (PLU), microprocessor, or other devices capable of executing and responding to instructions.

The processing unit may execute an operating system (OS) and one or more software applications running on the OS.

In response to software execution, the processing unit may access, store, manipulate, process, and generate data.

For the sake of simplicity, the processing unit may be described as a single entity, but it will be understood by those skilled in the art that the processing unit may include multiple processing elements and/or different types of processing elements.

For example, the processing unit may include multiple processors, or a processor and a controller.

Other processing configurations such as parallel processors may also be used.

The software may include computer programs, code, instructions, or a combination thereof, and may configure or collectively direct the processing unit to operate in a desired manner.

The software and/or data may be embodied—permanently or temporarily-in any type of machine, component, physical device, virtual equipment, computer-readable storage medium or device, or signal wave transmitted to the processing unit to be interpreted or executed.

The software may be distributed over a networked computer system and stored or executed in a distributed manner.

The software and data may be stored in one or more computer-readable recording media.

The method according to an embodiment may be implemented as a set of program instructions that may be executed by a computer and recorded on a computer-readable medium.

The computer-readable medium may include program instructions, data files, data structures, or combinations thereof.

The program instructions recorded on the medium may be specially designed and configured for the embodiments, or may be known and usable by those skilled in the field of computer software.

Examples of the computer-readable recording medium include magnetic media such as hard disks, floppy disks, and magnetic tapes; optical media such as CD-ROMs and DVDs; magneto-optical media such as floptical disks; and hardware devices specially configured to store and execute program instructions such as ROM, RAM, and flash memory.

Examples of program instructions include machine code generated by a compiler as well as high-level language code executable by a computer using an interpreter or the like.

Such hardware devices may be configured to operate as one or more software modules to perform the functions of the embodiments, and vice versa.

While the embodiments have been described with reference to specific drawings, it will be apparent to those skilled in the art that various modifications and changes can be made based on the above disclosure.

For example, the described techniques may be performed in a different order than illustrated, or the described systems, structures, devices, and circuits may be combined or integrated in different forms, or replaced with other components or equivalents while still achieving the intended results.

Accordingly, other implementations, modifications, and equivalents are to be considered as falling within the scope of the following claims.

What is claimed is:

1. A feature information comparison system for multimedia search, the system comprising:
a feature information extractor configured to extract feature information of each multimedia data from a plurality of multimedia data;
a quantization processor configured to quantize the extracted feature information and store the quantized feature information in a feature information database;
a clustering processor configured to cluster a set of target multimedia data by using the stored feature information, calculate a centroid of each cluster, and store the centroids in a cluster database;
a cluster searcher configured to compare a quantized value of the feature information extracted from a search input with the centroids in the cluster database, select one or more similar clusters based on the comparison, and designate multimedia data within the selected clusters as search candidates; and
a search result provider configured to compare the feature information of the multimedia data within the selected clusters with the feature information of the search input and provide a final search result based on the comparison.

2. The system of claim 1, wherein
the feature information extractor is configured to extract a feature vector of the input multimedia data using a Convolutional Neural Network (CNN)-based algorithm, and
the quantization processor is configured to convert the extracted feature vector using an n-bit quantization method.

3. The system of claim 1, wherein the clustering processor is configured to cluster the quantized feature information using a DBSCAN clustering algorithm and calculate a centroid for each cluster.

4. The system of claim 1, wherein the cluster searcher is configured to select c clusters similar to the quantized feature information of the search input and designate search candidates based on the quantized values of the multimedia data included in each selected cluster.

5. The system of claim 1, wherein the search result provider is configured to calculate a similarity by performing an XNOR operation between the quantized values and provide an optimal search result based on the calculated similarity.

6. The system of claim 1, wherein the cluster searcher is configured to selectively use either a Euclidean distance or a cosine similarity method when calculating distances between centroids in the cluster database.

7. The system of claim 1, wherein the search result provider is configured to perform a first similarity verification using the quantized values of the multimedia data in the candidate clusters and then perform a second verification using actual feature information.

8. The system of claim 1, wherein the clustering processor is configured to re-arrange clusters based on the quantized values of the multimedia data and automatically update the cluster centroids when new data is added.

9. A feature information comparison method for multimedia search, the method comprising:
extracting a feature vector from multimedia data using a CNN-based algorithm;
generating quantized feature information by applying an n-bit quantization method to the extracted feature vector;
quantizing a feature vector extracted from a search input and comparing the quantized input value with centroids in a cluster database to select c similar clusters as search candidates;
performing a first similarity verification by comparing the quantized feature information of the multimedia data in the selected clusters with the quantized feature information of the search input and filtering the candidate clusters based on the verification result; and
comparing the actual feature information of the multimedia data in the filtered candidate clusters with the feature information of the search input and providing top-k data with highest similarity as a final search result.

10. The method of claim 9, further comprising:
clustering a set of multimedia data by applying a DBSCAN clustering algorithm to the generated quantized feature information;
calculating a centroid for each clustered cluster;
storing the generated quantized feature information, quantized value, cluster ID, and cluster centroid for each multimedia data in a feature information database; and
storing the cluster information in a cluster database.

11. The method of claim 9, wherein the first similarity verification comprises:
calculating a similarity between the quantized feature information of the search input and the quantized feature information within the cluster using an XNOR operation; and
optimizing the calculation speed using a PopCount function.
